(19) United States
(12) Patent Application Publication
(10) Pub. No.: US 2019/0146939 A1
(43) Pub. Date: May 16, 2019

(54) COMMUNICATION DEVICE, COMMUNICATION METHOD, PROGRAM, AND COMMUNICATION SYSTEM

(71) Applicant: Sony Semiconductor Solutions Corporation, Kanagawa (JP)

(72) Inventors: Sonfun Lee, Kanagawa (JP); Hiroo Takahashi, Kanagawa (JP); Naohiro Koshisaka, Kanagawa (JP)

(73) Assignee: Sony Semiconductor Solutions Corporation, Kanagawa (JP)

(21) Appl. No.: 16/087,383

(22) PCT Filed: Apr. 7, 2017
(86) PCT No.: PCT/JP2017/014457

§ 371 Date: Sep. 21, 2018

(30) Foreign Application Priority Data
Apr. 22, 2016 (JP) 2016-086589

(51) Int. Cl. G06F 13/364; G06F 1/04; G06F 13/42; H04L 29/06

(52) U.S. Cl. CPC G06F 13/364; H04L 69/28; G06F 13/4291; G06F 1/04

(57) ABSTRACT

When communication with a slave becomes unavailable, a master instructs the slave to release a drive state for a data signal line, by having a transmission/reception unit perform particular driving of a clock signal line. The slave releases the drive state for the data signal line when a counter detects the particular driving of the clock signal line. The present technology can be applied to a bus IF that performs communication compatible with I3C standard, for example.

### TECHNICAL FIELD

The present disclosure relates to a communication device, a communication method, a program, and a communication system and, more particularly, relates to a communication device, a communication method, a program, and a communication system that can perform communication more stably.

### CROSS REFERENCE TO RELATED APPLICATIONS

This application claims the benefit of Japanese Priority Patent Application JP 2016-086589 filed on Apr. 22, 2016, the entire contents of which are incorporated herein by reference.

### BACKGROUND ART

In related art, an inter-integrated circuit (I2C), for example, is widely used as a bus interface (IF) used for communication between a plurality of devices via a bus within a board including the devices.

Further, in these years, it is desired to increase the speed of the I2C and an improved inter integrated circuit (I3C) has been defined as a next generation standard. In the I3C, a master and a slave can communicate with each other via two signal lines and, for example, a data transfer (a write transfer) from the master to the slave and a data transfer (a read transfer) from the slave to the master can be performed.

For example, PTL 1 discloses a digital data processing system in which a host processor and a subsystem controller are connected to each other via I2C. Further, PTL 2 discloses a method to realize a communication protocol layered above a standard I2C protocol.

### CITATION LIST

### Patent Literature

### PTL 1: JP 2000-99448A

### PTL 2: JP 2002-175269A

### SUMMARY OF INVENTION

### Technical Problem

However, in the above described I3C, for example, a deadlock may occur in the bus when an error occurs in serial data or serial clock transmitted via the two signal lines respectively. In this case, it is assumed that the communication is not performed by any of the master the slave and a proper communication is not performed.

The present disclosure is made in view of the above situation and helpful to perform communications stably.

### Solution to Problem

A communication device of a first aspect of the present disclosure includes: a transmission/reception unit configured to transmit and receive a signal to and from another communication device via at least two signal lines including a data signal line that transmits data and a clock signal line that transmits a clock; and a clear instruction unit configured to instruct the other communication device to release a drive state for the data signal line, by having the transmission/reception unit perform particular driving of the clock signal line, when the communication with the other communication device becomes unavailable.

A communication method or program of the first aspect of the present disclosure, includes: transmitting and receiving a signal to and from another communication device via at least two signal lines including a data signal line that transmits data and a clock signal line that transmits a clock; and instructing the other communication device to release a drive state for the data signal line, by performing particular driving of the clock signal line, when the communication with the other communication device becomes unavailable.

According to the first aspect of the present disclosure, transmission and reception of a signal are performed to and from another communication device via at least two signal lines including a data signal line that transmits data and a clock signal line that transmits a clock and, when the communication with the other communication device becomes unavailable, an instruction to release a drive state for the data signal line is sent to the other communication device by performing particular driving of the clock signal line.

A communication device of a second aspect of the present disclosure includes: a transmission/reception unit configured to transmit and receive a signal to and from another communication device via at least two signal lines including a data signal line that transmits data and a clock signal line that transmits a clock; and a detection unit configured to detect driving of the clock signal line by the other communication device, wherein the transmission/reception unit releases a drive state for the data signal line when the detection unit detects the particular driving of the clock signal line.

A communication method or program of the second aspect of the present disclosure, includes: transmitting and receiving a signal to and from another communication device via at least two signal lines including a data signal line that transmits data and a clock signal line that transmits a clock; detecting driving of the clock signal line by the other communication device; and releasing a drive state for the data signal line when particular driving of the clock signal line is detected.

According to the second aspect of the present disclosure, transmission and reception of a signal are performed to and from another communication device via at least two signal lines including a data signal line that transmits data and a clock signal line that transmits a clock and, when driving of the clock signal line by the other communication device is detected and particular driving of the clock signal line is detected, a drive state for the data signal line is released.

A communication system of a third aspect of the present disclosure includes: a first communication device including a first transmission/reception unit configured to transmit and receive a signal to and from a second communication device via at least two signal lines including a data signal line that transmits data and a clock signal line that transmits a clock, and a clear instruction unit configured to instruct the second communication device to release a drive state for the data signal line, by having the first transmission/reception unit perform particular driving of the clock signal line, when communication with the second communication device becomes unavailable; and the second communication device including a second transmission/reception unit configured to transmit and receive a signal to and from the first communication device via at least the two signal lines including the data signal line and the clock signal line, and a detection unit configured to detect driving of the clock signal line by the first communication device, wherein the second transmission/reception unit releases the drive state for the data signal line when the detection unit detects the particular driving of the clock signal line.

According to the third aspect of the present disclosure, transmission and reception of a signal are performed with a second communication device via at least two signal lines including a data signal line that transmits data and a clock signal line that transmits a clock and, when the communication with the second communication device becomes unavailable, an instruction to release a drive state for the data signal line is sent to the second communication device by performing particular driving of the clock signal line. On the other hand, transmission and reception of a signal is performed with a first communication device via at least the two signal lines including the data signal line and the clock signal line and, when driving by the first communication device for the clock signal line is detected and particular driving of the clock signal line is detected, a drive state for the data signal line is released.

### Advantageous Effects of Invention

According to an aspect of the present disclosure, communication can be performed more stably.

### BRIEF DESCRIPTION OF DRAWINGS

FIG. 1 is a block diagram illustrating a configuration example of an embodiment of a bus IF to which the present technology is applied.

FIG. 2 is a diagram illustrating a timing diagram in a case of a read transfer.

FIG. 3 is a diagram for explaining a condition that a clock slip occurs in a serial clock during the read transfer.

FIG. 4 is a diagram illustrating a timing diagram in a DDR mode.

FIG. 5 is a diagram for explaining a condition that a bit inversion error occurs in an HDR exit command.

FIG. 6 is a diagram for explaining a configuration example of a counter.

FIG. 7 is a diagram for explaining an example of a detection signal detected by the counter.

FIG. 8 is a diagram for explaining timing of a bus clear.

FIG. 9 is a flowchart for explaining a communication process performed by a master.

FIG. 10 is a flowchart for explaining a communication process performed by a slave.

FIG. 11 is a diagram for explaining a modification example of the bus clear.

FIG. 12 is a block diagram illustrating a configuration example of an embodiment of a computer to which the present technology is applied.

### DESCRIPTION OF EMBODIMENTS

Hereinafter, an embodiment to which the present technology is applied will be described in detail with reference to the drawings.

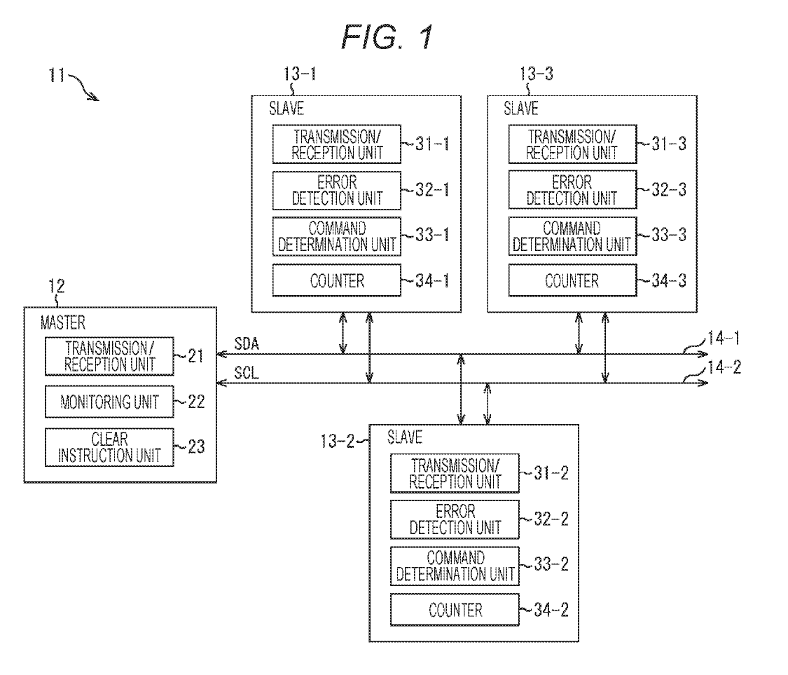

FIG. 1 is a block diagram illustrating a configuration example of an embodiment of a bus IF to which the present technology is applied.

The bus IF 11 illustrated in FIG. 1 includes a master 12 and three slaves 13-1 to 13-3, which are connected via a data signal line 14-1 and a clock signal line 14-2.

The master 12 is in control of operation in the bus IF 11 and can communicate with the slaves 13-1 to 13-3 via the data signal line 14-1 and clock signal line 14-2.

The slaves 13-1 to 13-3 can communicate with the master 12 via the data signal line 14-1 and clock signal line 14-2 according to the control by the master 12. Here, since the slaves 13-1 to 13-3 respectively has a similar configuration, the slaves 13-1 to 13-3 will be simply referred to as a slave 13 when it is not particularly needed to distinguish, and respective blocks in the slave 13 will be referred in the similar manner.

The data signal line 14-1 and clock signal line 14-2 are used to transmit signals between the master 12 and slave 13. For example, in the bus IF 11, serial data (SDA) is sequentially transmitted bit by bit via the data signal line 14-1, and a serial clock (SCL) having a predetermined frequency is transmitted via the clock signal line 14-2.

Further, in the bus IF 11, a plurality of transmission methods with different communication rates are defined and the master 12 can switch those transmission methods. For example, in the bus IF 11, according to data transfer rates, a standard data rate (SDR) mode to perform data communication in a normal transfer rate and a high data rate (HDR) mode to perform data communication in a transfer rate higher than the SDR mode are defined. Further, in the HDR mode, three modes of a double data rate (DDR) mode, a ternary symbol pure-bus (TSP) mode, and a ternary symbollegacy-inclusive-bus (TSL) mode are defined as standards. Here, in the bus IF 11, it is defined that communication is performed in the SDR mode when the communication is started.

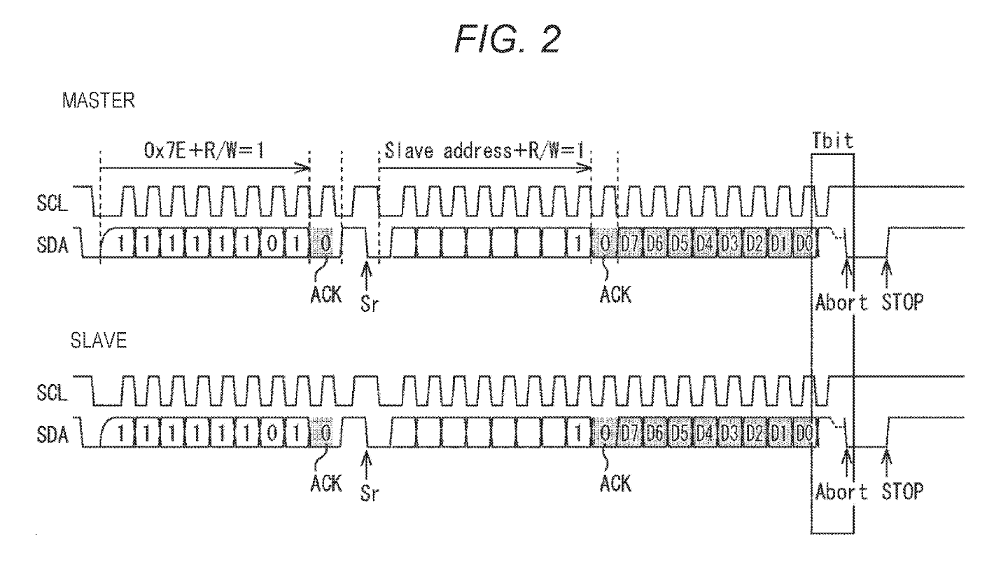

Here, as described above, when an error occurs in serial data transmitted via the data signal line 14-1 or in the serial clock transmitted via the clock signal line 14-2, the bus IF 11 may be deadlocked and this may disable the communication. Here, before explaining configurations of the master 12 and slave 13, a deadlock occurs in the bus IF 11 will be described with reference to FIGS. 2 to 5. Here, in the following drawings, the serial data illustrated with hatching represents data that is transmitted from the slave 13 to the master 12 and it is in a condition that the slave 13 can drive the data signal line 14-1.

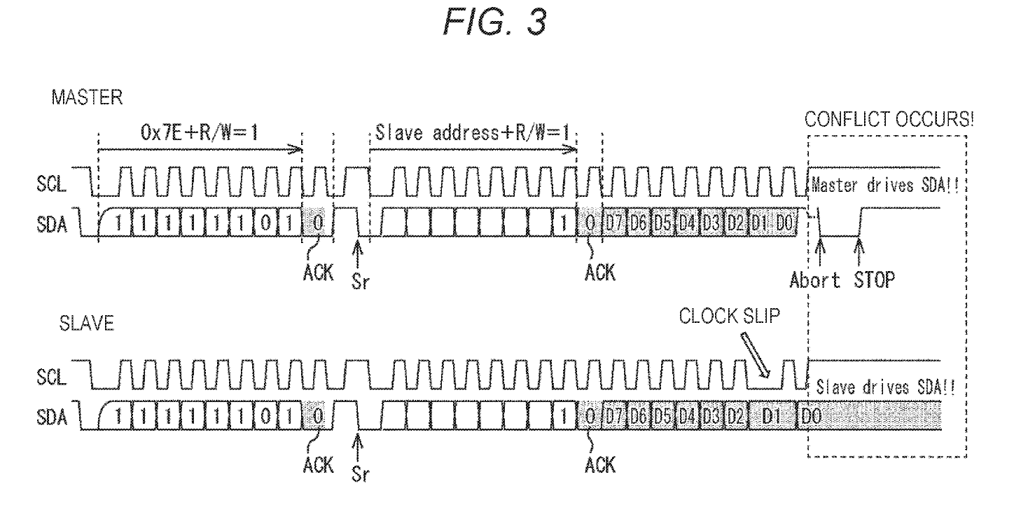

For example, as will be described with reference to FIGS. 2 and 3, when data transfer from the slave 13 to the master 12 (hereinafter, referred to as a read transfer) is performed and an error occurs in the bus IF 11, the bus IF 11 may be deadlocked. In FIGS. 2 and 3, waveforms seen from the master 12 are illustrated in the upper side and waveforms seen from the slave 13 are illustrated in the lower side.

FIG. 2 is a timing diagram in a read transfer.

As illustrated in FIG. 2, for example, the master 12 transmits a broadcast command (0x7E+R/W=1) to inform that a command is transmitted to all slaves 13 in the bus IF 11. After that, the master 12 receives acknowledgements (ACK) transmitted from the slaves 13 to confirm the broadcast command is successfully received and then starts communication again (Sr). Then, the master 12 transmits an address (Slave address+R/W=1) of the slave 13 which is a target of the read transfer and receives data (D0 to D7) transmitted from the slave 13.

Here, in the bus IF 11, during the read transfer, a period (hereinafter, referred to as a T bit) that the master 12 can abort the read transfer is defined every one byte of the read data. Thus, the master 12 can abort the read transfer by driving the data signal line 14-1 to be in an L level (SDA=0) at the T bit. After that, to end the communication, the master 12 outputs a stop condition (drives the data signal line 14-1 to be an H level from the L level while the clock signal line 14-2 is at the H level) and can inform that the communication ends. Here, at the T bit, the slave 13 is not allowed to drive the data signal line 14-1.

FIG. 3 illustrates a condition that a clock slip occurs in a serial clock during the read transfer.

As illustrated in FIG. 3, when a clock slip occurs in serial clock during a read transfer, since a cycle of the serial clocks between the master 12 and slave 13 are shifted, there may be caused a recognition gap of the period of the T bit to abort the read transfer. In this manner, when there is a recognition gap of the period of the T bit, the master 12 can drive the data signal line 14-1 to the L level to end the read transfer during the period that the master 12 itself recognizes as the T bit. However, since the slave 13 does not recognize the period as the T bit (there is a perception gap regarding the T bit period), the slave 13 may drive the data signal line 14-1.

Accordingly, in this case, when both of the master 12 and slave 13 drive the data signal line 14-1, this causes a bus conflict. Then, as the slave 13 keeps recognizing that it is allowed to drive the data signal line 14-1, a deadlocked occurs in the bus IF 11. Thus, the master 12 dose not output a stop condition and it is difficult to end the communication and start over the communication process.

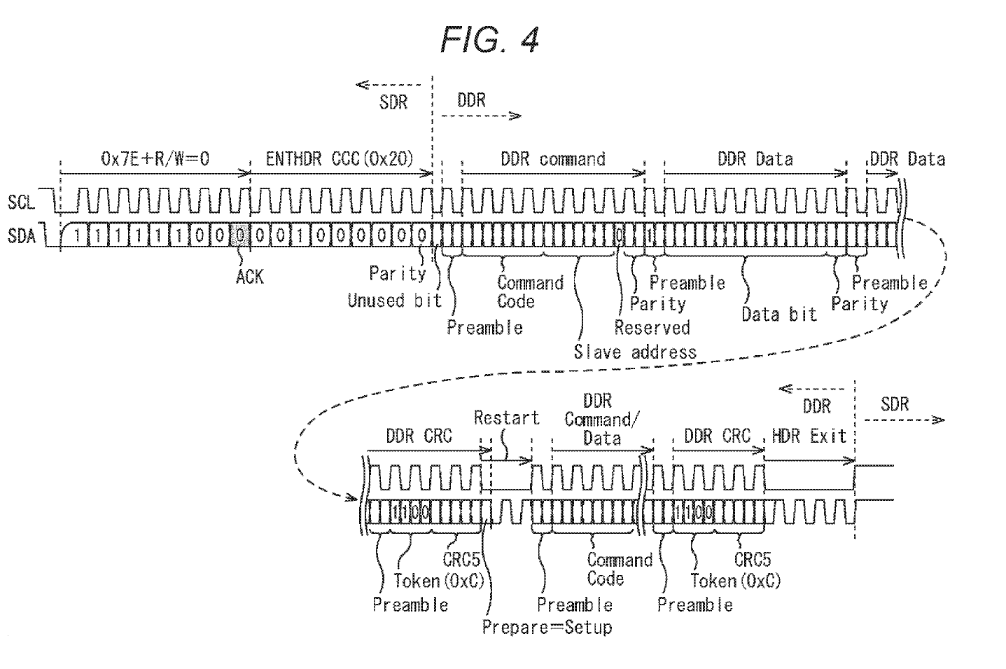

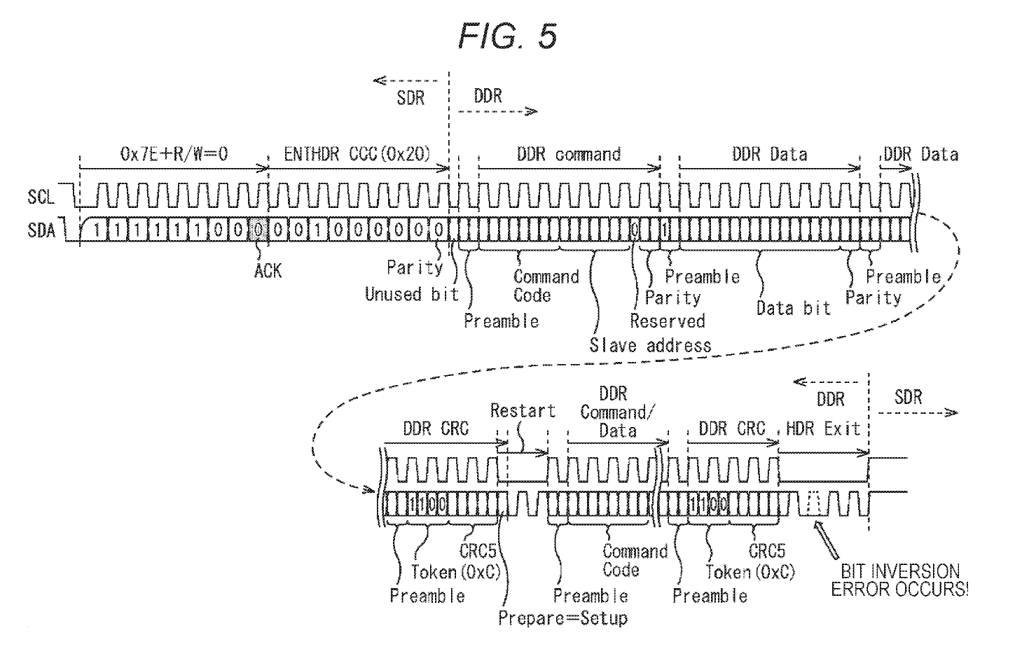

Further, as will be described with reference to FIGS. 4 and 5, when a transfer error occurs in the HDR mode, a deadlock may occur in the bus IF 11.

FIG. 4 illustrates a timing diagram in a DDR mode (a high speed transfer mode), which is one of the HDR modes.

As illustrated in FIG. 4, the master 12 firstly transmits, in the SDR mode, a broadcast command (0x7E+R/W=0) informing a transmission of a command to all slaves 13 in the bus IF 11 at the same time. After that, the master 12 receives ACKs transmitted from the slaves 13 to confirm that the broadcast command is successfully received and transmits a common command code (ENTHDR CCC(0x20)) to switch to the DDR mode. In this manner, after informing the slaves 13 of a switch to the DDR mode and then switching to the DDR mode, the master 12 performs a data transfer (transmission of a DDR command, DDR data, or the like) in the DDR mode.

Then, to end the data transfer in the DDR mode, the master 12 transmits an HDR exit command (HDR Exit) to inform the slave 13 that the HDR mode is ended.

FIG. 5 illustrates a condition that a bit inversion error occurs in the HDR exit command.

When a bit inversion error occurs in the HDR exit command as illustrated in FIG. 5, the slave 13 does not recognize that the DDR mode is ended. In this case, since rules of the protocol in the SDR mode and DDR mode are considerably different, there may be a possibility that a bus conflict occurs in subsequent protocol and a deadlock occurs in the bus IF 11.

As described above, when a clock slip occurs in a serial clock or a bit inversion error occurs in the HDR exit command during a read transfer, there may be a possibility that a deadlock occurs in the bus IF 11.

For example, in a case that the bus IF 11 is deadlocked, in related art, there is an assumed method to block power of the entire system or to reset via another equipment to recover the system. However, when the master 12 is not in control of blocking the power or is not in control of resetting the system, the system is not reset. Thus, a deadlock in the bus IF 11 is not cleared in related art. Further, when the power of the entire system is blocked, there may be undesirable effects such that a period of time that the system is completely stopped occurs or register information such as a setting value of the entire system is initialized. Further, to recover the system by resetting via another equipment, there may be undesirable effects such that the register information such as a setting value of the entire system is initialized.

Thus, the master 12 and slave 13 of the bus IF 11 are made to clear the deadlock of the bus IF 11 (hereinafter, referred to as bus clear) and recovers a condition that communication is available without causing the above described undesirable effects.

Next, configurations of the master 12 and slave 13 in FIG. 1 will be described.

The master 12 includes a transmission/reception unit 21, a monitoring unit 22, and a clear instruction unit 23.

The transmission/reception unit 21 transmits and receives signals to and from the slave 13 via the data signal line 14-1 and clock signal line 14-2. For example, the transmission/reception unit 21 transmits signals to the slave 13 by driving the data signal line 14-1 (switching the potential to the H level or L level) corresponding to timing of the serial clock transmitted by driving the clock signal line 14-2. Further, the transmission/reception unit 21 receives signals transmitted from the slave 13 by that the slave 13 drives the data signal line 14-1 corresponding to timing of the serial clock of the clock signal line 14-2. Here, the clock signal line 14-2 is typically driven by the master 12.

The monitoring unit 22 monitors a communication condition of the bus IF 11 and determines whether or not the bus IF 11 is deadlocked, for example. For example, in the bus IF 11, it is defined that a predetermined command is successfully received when the slave 13 responses to the master 12 by transmitting an ACK in response to the command, which is transmitted from the master 12 to the slave 13. Thus, when there is no response from the slave 13 in the bus IF 11 and the communication condition is not improved even when various recovery methods for the slave 13 are performed by the transmission/reception unit 21, the monitoring unit 22 may determine that the bus IF 11 is deadlocked. Alternatively, the monitoring unit 22 may also determine that the bus IF 11 is deadlocked when a bus conflict occurs in a section where a bus conflict may not occur in usual. For example, the monitoring unit 22 compares a value of serial data transmitted from the master 12 with a value of serial data received at that time and recognizes that a bus conflict has occurred when those values are different.

When the monitoring unit 22 determines that the bus IF 11 is deadlocked, the clear instruction unit 23 instructs the slave 13 to release the drive state for the data signal line 14-1, by having the transmission/reception unit 21 perform particular driving of the clock signal line 14-2. Here, as the particular driving, the clear instruction unit 23 maintains the clock signal line 14-2 at the L level until a certain period of time (for example, one millisecond) passes for example and then performs driving to switch the clock signal line 14-2 to the H level.

In this manner, when the slave 13 detects that the particular driving is performed for the clock signal line 14-2, the slave 13 releases the drive state for the data signal line 14-1 and the deadlock in the bus IF 11 is cleared.

The slave 13 includes a transmission/reception unit 31, an error detection unit 32, a command determination unit 33, and a counter 34.

The transmission/reception unit 31 transmits and receives signals to and from the master 12 via the data signal line 14-1 and clock signal line 14-2. For example, the transmission/reception unit 31 receives a signal transmitted from the master 12 by that the master 12 drives the data signal line 14-1 corresponding to timing of the serial clock of the clock signal line 14-2. Further, the transmission/reception unit 31 transmits a signal to the master 12 by driving the data signal line 14-1 corresponding to timing of the serial clock of the clock signal line 14-2.

The error detection unit 32 detects an error occurred in the signal received by the transmission/reception unit 31, by, for example, performing a parity check or a cyclic redundancy check (CRC) on the signal received by the transmission/reception unit 31 or checking a bit sequence that composes the command. Then, when the error detection unit 32 detects that there is an error in the signal received by the transmission/reception unit 31 for example, the error detection unit 32 can process the error, that is, for example, requesting retransmission of the command.

The command determination unit 33 determines the content of the command included in the signal received by the transmission/reception unit 31 and instructs each processing unit (not shown) that performs a process corresponding to the content of each command to perform a process based on the command.

The counter 34 performs outputting corresponding to the time based on the count, for example, by counting a period of time when the data signal line 14-1 is at the H level or L level or counting a period of time when the clock signal line 14-2 is at the H level or L level. For example, the counter 34 can be used as a detection unit that detects driving of the clock signal line 14-2 by the master 12. Thus, the counter 34 maintains the clock signal line 14-2 at the L level until a certain period of time (for example, one millisecond) passes as described above and then can detect that particular driving to switch the clock signal line 14-2 to the H level has performed.

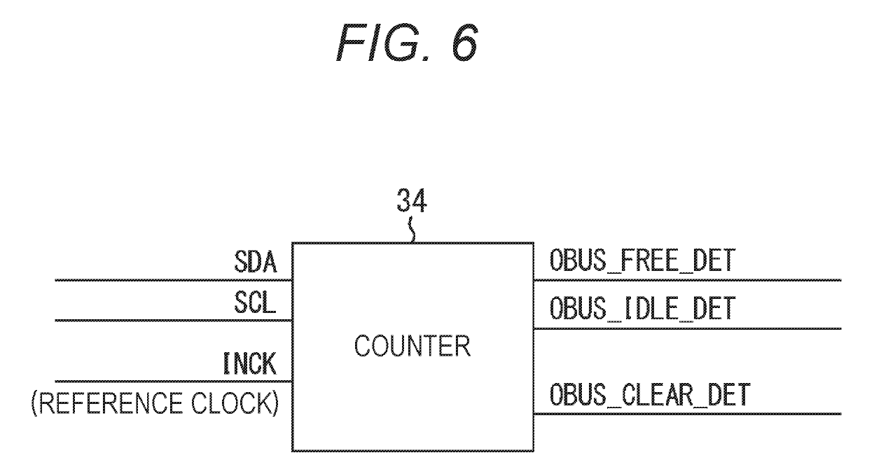

More specifically, as illustrated in FIG. 6, to the counter 34, the serial data transmitted via the data signal line 14-1, the serial clock transmitted via the clock signal line 14-2, and a reference clock (INCK) generated in an unillustrated oscillator are input. For example, the counter 34 counts the period of time when the serial clock is at the L level and, when detecting that the L level is maintained for a certain period of time (for example, one millisecond) and particular driving for switching to the H level is performed, outputs a bus clear detection signal (OBUS_CLEAR_DET), which is a detection of an instruction to release the drive state for the data signal line 14-1. When the transmission/reception unit 31 releases the drive state for the data signal line 14-1 in response to the above, the deadlock in the bus IF 11 is cleared.

Here, the counter 34 is also used to output other detection signals in addition to the bus clear detection signal (OBUS_CLEAR_DET).

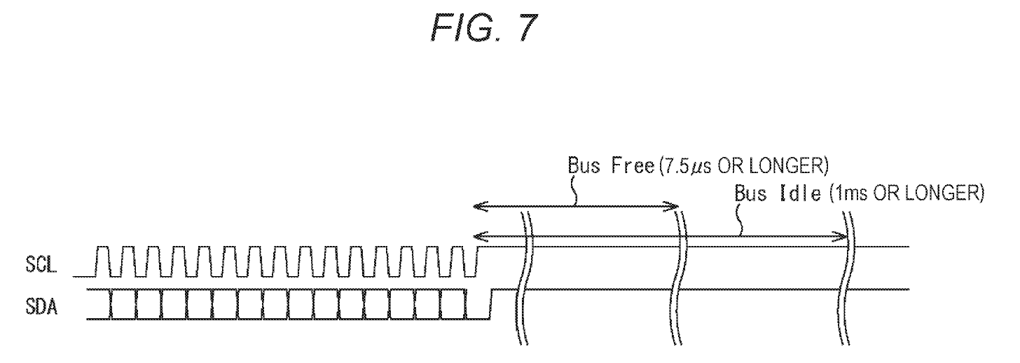

For example, as illustrated in FIG. 7, when it is detected that a period of time when the serial data and serial clock are at the H level is 7.5 μs or longer, the counter 34 outputs a detection signal (OBUS_FREE_DET) that detects that a transaction such as an interruption can be performed. Further, when it is detected that the period of time when the serial data and serial clock are at the H level is one ms or longer, the counter 34 outputs a detection signal (OBUS_IDLE_DET) that detects a hot join is available.

In this manner, with the counter 34 used for outputting another detection signal, the slave 13 can easily detect that an instruction to release the drive state for the data signal line 14-1 is sent.

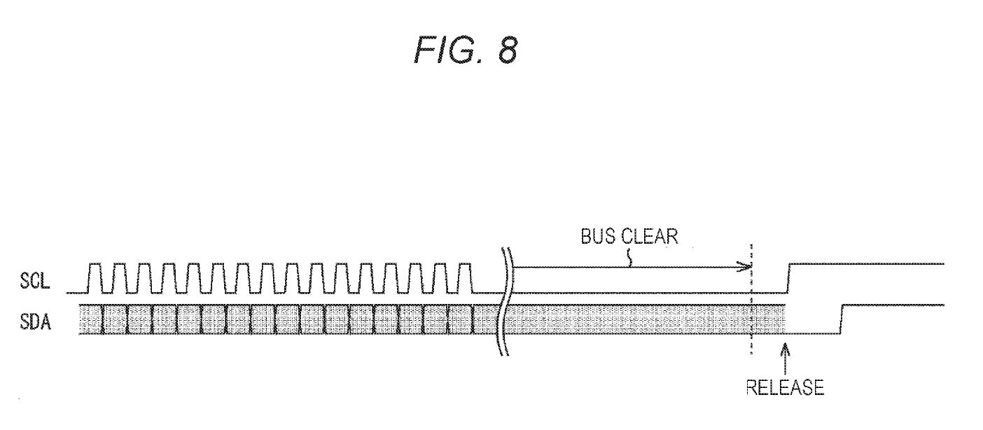

Then, as illustrated in FIG. 8, when the slave 13 is allowed to drive the data signal line 14-1, the master 12 can instruct the slave 13 to perform a bus clear, by maintaining the clock signal line 14-2 at the L level until a certain period of time (for example, one millisecond) passes. At the timing when the certain period of time has passed, the slave 13 can detect that a bus clear is instructed.

After that, at the timing that the master 12 switches the clock signal line 14-2 to the H level, the slave 13 releases the drive state for the data signal line 14-1. With this, the master 12 is in control again and the deadlock in the bus IF 11 can be cleared.

Here, for example, when the slave 13 performs the release at timing of detecting that the clock signal line 14-2 is maintained at the L level for a certain period of time (for example, one millisecond), there may be generated a gap in timings of the bus clear detection in each slave 13 and it is not preferable to perform the release at those timings. In other words, when the plurality of slaves 13 are in the drive state to be allowed to drive the data signal line 14-1, the respective slaves 13 may perform the release at different timings. Accordingly, confusion may be caused since electrical stress is generated in the data signal line 14-1 or signals such as HDR RESTART or HDR EXIT are generated.

Thus, in the bus IF 11, it is preferable that the slaves 13 release the drive state for the data signal line 14-1 at timing when the master 12 switches the clock signal line 14-2 to the H level.

The bus IF 11 is configured as described above and, when the bus IF 11 is deadlocked, the master 12 can instruct the slave 13 to clear the bus by using the clock signal line 14-2 and the communication by the bus IF 11 can be recovered.

<Communication Method for Clearing Bus>

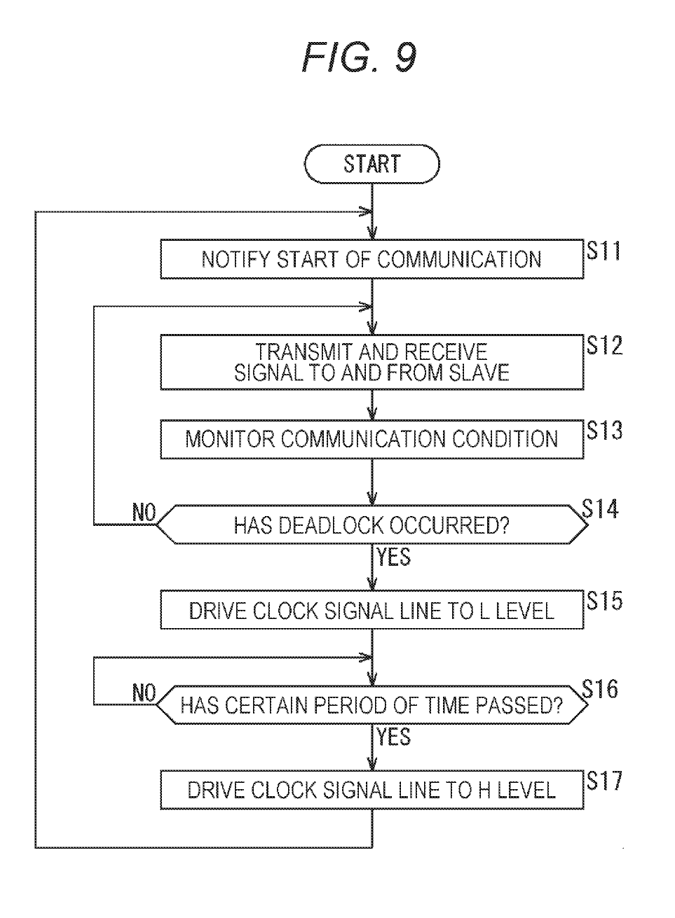

FIG. 9 is a flowchart for explaining a communication process performed in the master 12.

For example, the process is started when an instruction to perform communication is sent to the master 12 from an unillustrated upper control device. Then, in step S11, the transmission/reception unit 21 drives the data signal line 14-1 and clock signal line 14-2, outputs a start condition (drives the data signal line 14-1 to switch from the H level to the L level while the clock signal line 14-2 is at the H level), and informs the start of the communication.

In step S12, the transmission/reception unit 21 transmits and receives signals to and from the slave 13 via the data signal line 14-1 and clock signal line 14-2.

The monitoring unit 22 monitors, in step S13, the communication condition of the bus IF 11 and determines, in step S14, whether or not the bus IF 11 is deadlocked on the basis of the monitoring result. When the monitoring unit 22 determines that the bus IF 11 is not deadlocked in step S14, the process returns to step S12 to sequentially continue the communication with the slave 13 in a similar manner and, after the communication is properly ended, the process returns to step S11 and communication can be newly started.

On the other hand, when the monitoring unit 22 determines that the bus IF 11 is deadlocked in step S14, the process proceeds to step S15.

In step S15, in response to the determination by the monitoring unit 22 that the bus IF 11 is deadlocked in step S14, the clear instruction unit 23 instructs the transmission/reception unit 21 to drive the clock signal line 14-2 to the L level. According to the instruction, the transmission/reception unit 21 drives the clock signal line 14-2 to the L level (SCL=L).

In step S16, the clear instruction unit 23 determines whether or not a certain period of time has passed since the transmission/reception unit 21 drives the clock signal line 14-2 to the L level in step S15, and waits to proceed the process until it is determined that a certain period of time has passed.

In step S16, when the clear instruction unit 23 determines that the certain period of time has passed since the transmission/reception unit 21 drives the clock signal line 14-2 to the L level in step S15, the process proceeds to step S17.

In step S17, the clear instruction unit 23 instructs the transmission/reception unit 21 to drive the clock signal line 14-2 to the H level and the transmission/reception unit 21 drives the clock signal line 14-2 to the H level (SCL=H). With this configuration, the bus clear is performed as described above with reference to FIG. 8.

After the process in step S17, the process returns to step S11 and the master 12 can start over the communication from the beginning.

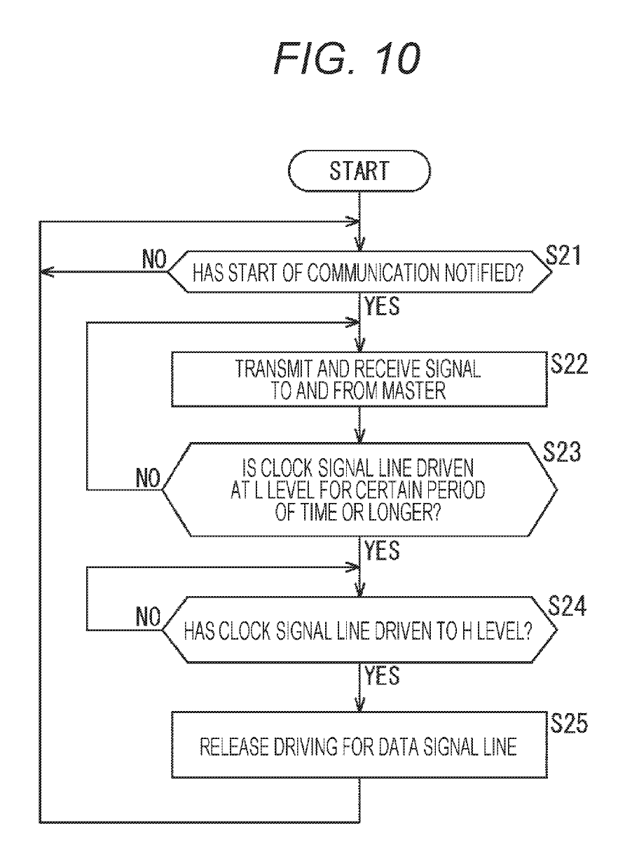

FIG. 10 is a flowchart for explaining the communication process performed in the slave 13.

For example, the slave 13 is in a standby state to wait for communication from the master 12, and in step S21, the transmission/reception unit 31 determines whether or not the master 12 has informed a start of communication and waits to proceed the process until it is determined that the master 12 has informed the start of the communication.

For example, when the master 12 outputs a start condition in step S11 of FIG. 9, the transmission/reception unit 31 determines that the master 12 has informed a start of the communication in step S21, and proceeds to the process in step S22.

In step S22, the transmission/reception unit 31 transmits and receives signals to and from the master 12 via the data signal line 14-1 and clock signal line 14-2.

In step S23, the counter 34 determines whether or not a certain period of time has passed since the clock signal line 14-2 is driven to the L level. When the counter 34 determines that the certain period of time has not passed since the clock signal line 14-2 is driven to the L level in step S23, the process returns to step S22 to sequentially continue the communication with the master 12 in a similar manner and, after the communication properly ends, the process returns to step S21 to wait for communication newly started.

On the other hand, when the counter 34 determines that the certain period of time has passed since the clock signal line 14-2 is driven to the L level in step S23, the process proceeds to step S24.

In step S24, the transmission/reception unit 31 determines whether or not the clock signal line 14-2 is driven to the H level, and waits to proceed the process until it is determined that the clock signal line 14-2 is driven to the H level.

When the transmission/reception unit 31 determines, in step S24, that the clock signal line 14-2 is driven to the H level, the process proceeds to step S25 and the transmission/reception unit 31 releases driving of the data signal line 14-1. After that, the process returns to step S21 and the slave 13 becomes in a standby state to wait for communication from the master 12.

As described above, when the bus IF 11 is deadlocked, the master 12 and slave 13 can recover the communication by clearing the bus, and the communication can be performed more stably.

Here, according to the present embodiment, as the particular driving by the master 12 to instruct the slave 13 to clear the bus, there has been explained a drive method for maintaining the clock signal line 14-2 at the L level for a certain period of time; however, the drive method does not set any limitation. For example, as the particular driving to instruct the slave 13 to clear the bus, a drive method that the master 12 maintains the clock signal line 14-2 at the H level until a certain period of time passes may be used. Further, the timing that the slave 13 releases the data signal line 14-1 is not limited to the timing when the master 12 drives the clock signal line 14-2 to the H level and, for example, the slave 13 may be made to release the data signal line 14-1 when a particular pattern is transmitted.

In other words, as long as the master 12 can instruct the slave 13 to clear the bus by performing a particular driving of the clock signal line 14-2, various patterns may be used as the driving in those cases. For example, the master 12 may instruct the slave 13 to clear the bus by performing driving to transmit a serial clock in combination of a normal frequency and a higher frequency. Further, for example, the master 12 may instruct the slave 13 to clear the bus by performing driving to repeat switching the L level for a certain period of time and the H level for a certain period of time at a predetermined number of times, with the number of edges generated by switching the levels. Here, a pattern generated by combining these driving may be used.

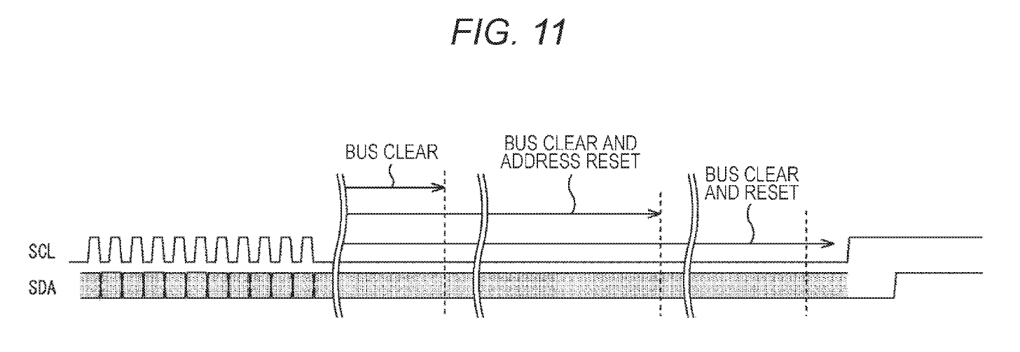

Further, for example, as illustrated in FIG. 11, by properly setting the certain period of time to maintain the clock signal line 14-2 at the L level, the master 12 can instruct the slave 13 not only to clear the bus but also to clear the bus and reset the address or to clear the bus and reset the settings (reset all the I3C settings to initial values). Further, by properly setting the certain period of time to maintain the clock signal line 14-2 at the L level, the master 12 can instruct the slave 13 to reset or set a predetermined set value other than the address. In this manner, even when the bus IF 11 is deadlocked, the master 12 can give various instructions (setting or resetting) to the slave 13 by performing particular driving of the clock signal line 14-2. This configuration can avoid the condition that the communication is not performed at all, even when a deadlock occurs in the bus IF 11.

Further, as described with reference to FIGS. 9 and 10, in the bus IF 11, the monitoring unit 22 can monitor the deadlock in the bus IF 11 at all times even when the communication process is not being performed since the monitoring unit 22 also monitors the communication condition of the bus IF 11 when the communication process is not being performed. Then, when the monitoring unit 22 detects that the bus IF 11 is deadlocked, the master 12 can instruct the slave 13 to clear the bus in any situation.

Here, the present technology is not limited to the bus IF 11 compatible with the I3C standard and can be applied to the bus IF 11 compatible with any other standard. Further, regarding the bus IF 11 illustrated in FIG. 1, a configuration example in which the slaves 13-1 to 13-3 are connected is illustrated; however, the number of the slaves 13 may be, for example, one, two, or more than three.

Here, the processes described with reference to the above flowcharts do not have to be performed in chronological order according to the order of the described flowchart, and may include processes performed in parallel or individually (for example, parallel processing or processing by an object). Further, the program may be processed by a single CPU or may be distributed and processed by a plurality of CPUs.

Further, according to the present disclosure, the system represents an entire device that is composed of a plurality of devices.

Further, the above described series of processes may be executed by hardware or may be executed by software. In a case that the series of the processes is executed by software, a program composing the software is installed, via a program recording medium in which the program is recorded, to a computer including a dedicated hardware or a general personal computer or the like, in which various functions can be executed by installing various programs, for example.

<Configuration Example of Hardware>

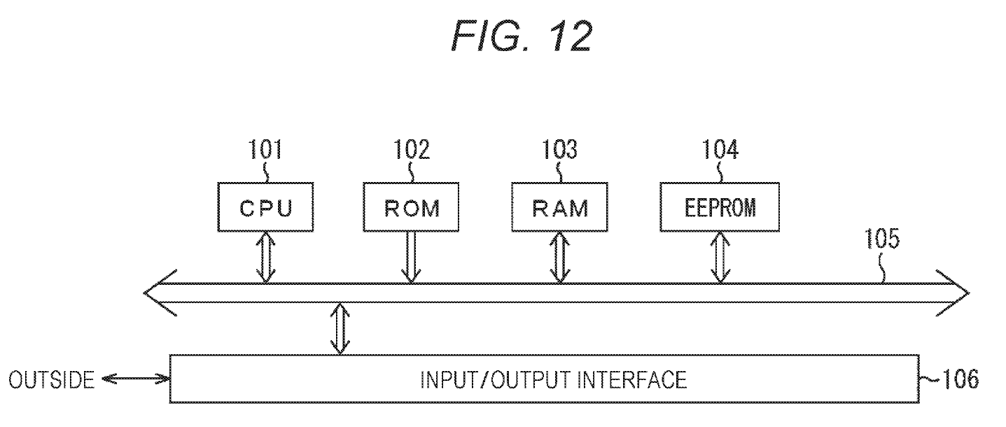

FIG. 12 is a block diagram illustrating a configuration example of hardware of a computer that executes the above described series of processes with the program.

In the computer, a central processing unit (CPU) 101, a read only memory (ROM) 102, a random access memory (RAM) 103, and an electronically erasable and programmable read only memory (EEPROM) 104 are connected one another via a bus 105. To the bus 105, an input/output interface 106 is further connected and the input/output interface 106 is connected to the outside (for example, the signal lines 14-1 and 14-2 of FIG. 1).

In the computer composed as described above, when the CPU 101 loads a program stored in the ROM 102 and EEPROM 104 for example to the RAM 103 via the bus 105 and executes the program, the above series of processes are executed. Further, the program executed by the computer (CPU 101) may be written in the ROM 102 in advance or may be installed or updated in the EEPROM 104 from the outside via the input/output interface 106.

Here, the present technology may employ the following configurations.

(1)
A communication device including:
a transmission/reception unit configured to transmit and receive a signal to and from another communication device via at least two signal lines including a data signal line that transmits data and a clock signal line that transmits a clock; and
a clear instruction unit configured to instruct the other communication device to release a drive state for the data signal line, by having the transmission/reception unit perform particular driving of the clock signal line, when the communication with the other communication device becomes unavailable.
(2)
The communication device according to (1), wherein the transmission/reception unit maintains the clock signal line at an L level, as the particular driving, until a certain period of time passes and, after that, drives the clock signal line to be at an H level.
(3)
The communication device according to (1) or (2), wherein the transmission/reception unit maintains the L level, as the particular driving, until a first period of time that is longer then the certain period of time passes and, after that, instructs the other communication device to release the drive state for the data signal line and reset a predetermined setting value, by driving the clock signal line to switch to the H level.
(4)
The communication device according to any of (1) to (3), wherein the transmission/reception unit maintains the L level, as the particular driving, until a second period of time that is longer than the certain period of time passes and, after that, instructs the other communication device to release the drive state for the data signal line and reset all settings, by driving the clock signal line to switch to the H level.
(5)
The communication device according to any of (1) to (4), further including a monitoring unit configured to monitor communication with a plurality of the other communication devices and determine whether or not a deadlock occurs in the communication via the data signal line and the clock signal line.
(6)
A communication method, including:
transmitting and receiving a signal to and from another communication device via at least two signal lines including a data signal line that transmits data and a clock signal line that transmits a clock; and
instructing the other communication device to release a drive state for the data signal line, by performing particular driving of the clock signal line, when the communication with the other communication device becomes unavailable.
(7)
A program that causes a computer to execute a communication process including:
transmitting and receiving a signal to and from another communication device via at least two signal lines including a data signal line that transmits data and a clock signal line that transmits a clock; and
instructing the other communication device to release a drive state for the data signal line, by performing particular driving of the clock signal line, when the communication with the other communication device becomes unavailable.
(8)
A communication device including:
a transmission/reception unit configured to transmit and receive a signal to and from another communication device via at least two signal lines including a data signal line that transmits data and a clock signal line that transmits a clock; and
a detection unit configured to detect driving of the clock signal line by the other communication device,
wherein the transmission/reception unit releases a drive state for the data signal line when the detection unit detects the particular driving of the clock signal line.
(9)
The communication device according to (8), wherein the transmission/reception unit releases the drive state for the data signal line, when it is detected that the driving to switch the clock signal line to the H level is performed after the clock signal line is maintained in an L level, as the particular driving, until a certain period of time passes.
(10)
The communication device according to (8) or (9), wherein the transmission/reception unit releases the drive state for the data signal line and resets a predetermined setting value, when it is detected that the driving to switch the clock signal line to the H level is performed after the L level is maintained, as the particular driving, until a first period of time that is longer than the certain period of time passes.
(11)
The communication device according to any of (8) to (10), wherein the transmission/reception unit releases the drive state for the data signal line and resets all settings, when it is detected that driving to switch the clock signal line to the H level is performed after the L level is maintained, as the particular driving, until a second period of time that is longer than the certain period of time passes.
(12)
The communication device according to any of (8) to (11), wherein the detection unit is a counter that counts the time when the clock signal line is at the L level.
(13)
A communication method, including:
transmitting and receiving a signal to and from another communication device via at least two signal lines including a data signal line that transmits data and a clock signal line that transmits a clock;
detecting driving of the clock signal line by the other communication device; and releasing a drive state for the data signal line when particular driving of the clock signal line is detected.
(14)
A program that causes a computer to execute a communication process including:
transmitting and receiving a signal to and from another communication device via at least two signal lines including a data signal line that transmits data and a clock signal line that transmits a clock;
detecting driving of the clock signal line by the other communication device; and releasing a drive state for the data signal line when particular driving of the clock signal line is detected.
(15)
A communication system including:
a first communication device including
a first transmission/reception unit configured to transmit and receive a signal to and from a second communication device via at least two signal lines including a data signal line that transmits data and a clock signal line that transmits a clock, and
a clear instruction unit configured to instruct the second communication device to release a drive state for the data signal line, by having the first transmission/reception unit perform particular driving of the clock signal line, when the communication with the second communication device becomes unavailable; and
the second communication device including
a second transmission/reception unit configured to transmit and receive a signal to and from the first communication device via at least the two signal lines including the data signal line that transmits data and the clock signal line that transmits a clock, and a detection unit configured to detect driving of the clock signal line by the first communication device,
and the second transmission/reception unit releases the drive state for the data signal line when the detection unit detects the particular driving of the clock signal line.

Here, the present embodiment is not limited to the above described embodiment and various changes can be made within the scope of the present disclosure.

### REFERENCE SIGNS LIST

11 Bus IF
12 Master
13 Slave
14-1 Data signal line
14-2 Clock signal line
21 Transmission/reception unit
22 Monitoring unit
23 Clear instruction unit
31 Transmission/reception unit
32 Error detection unit
33 Command determination unit
34 Counter

1. A communication device comprising:
transmission and reception circuitry configured to communicate with an external communication device via a data signal line and a clock signal line, the communication including transmitting and receiving data via the data signal line and transmitting a clock via the clock signal line; and
control circuitry configured to:
monitor a communication condition of at least one of the data signal line and the clock signal line, and
cause the clock signal line to stay at a predetermined level for a predetermined period of time, in response to a determination relating to the communication condition.

2. The communication device according to claim 1, wherein the predetermined level is an L clock level.

3. The communication device according to claim 2, wherein the control circuitry is configured to cause the transmission and reception circuitry to drive the clock signal line to an H clock level after the predetermined period of time has elapsed.

4. The communication device according to claim 3, wherein the communication device receives transmission rights from the external communication device before the clock signal line is driven to the H clock level.

5. The communication device according to claim 3, wherein the control circuitry is configured to cause the transmission and reception circuitry to transmit a stop signal by driving the data signal line to an H data level after the clock signal line is driven to the H clock level.

6. The communication device according to claim 1, wherein the control circuitry is configured to cause the external communication device to release a drive state of the data signal line.

7. The communication device according to claim 1, wherein the communication device is a master and the external communication device is one of a plurality of slaves.

8. A communication device, comprising:
transmission and reception circuitry configured to communicate with an external communication device via a data signal line and a clock signal line, the communication including transmitting and receiving data via the data signal line and receiving a clock via the clock signal line; and
control circuitry configured to:
determine an error condition of the data signal line or the clock signal line,
count a period of time during which the data signal line is at a first predetermined level, or during which the clock signal line is at a second predetermined level, and
release a drive state of the data signal line when the period of time exceeds a predetermined value.

9. The communication device according to claim 8, wherein the determination of the error condition is a detection of an error in one bit of the data.

10. The communication device according to claim 8, wherein the first predetermined level is an H data level or an L data level, and the second predetermined level is an H clock level or an L clock level.

11. The communication device according to claim 7, wherein:
the second predetermined level is an L clock level,
the control circuitry is configured to transfer transmission rights to the external communication device when the period of time exceeds the predetermined value, and
the control circuitry is configured to detect the clock signal line being driven to an H clock level after releasing the drive state of the data signal line.

12. The communication device according to claim 11, wherein the control circuitry is configured to receive a stop signal by detecting the data signal line being driven to an H data level after detecting the clock signal line being driven to the H clock level.

13. The communication device according to claim 8, wherein the communication device is one of a plurality of slaves and the external communication device is a master.

14. A communication system comprising:
a first communication device, including:
first transmission and reception circuitry configured to communicate via a data signal line and a clock signal line, the communication including transmitting and receiving data via the data signal line and a transmitting a clock via the clock signal line, and
first control circuitry configured to:
monitor a first communication condition of at least one of the data signal line and the clock signal line, and
cause the clock signal line to stay at a first predetermined level for a predetermined period of time, in response to a determination relating to the first communication condition; and
a second communication device including second transmission and reception circuitry configured to communicate with the first communication device via the data signal line and the clock signal line, the communication including transmitting and receiving data via the data signal line and receiving the clock via the clock signal line.

15. The communication system according to claim 14, the second communication device including second control circuitry configured to:
determine an error condition of the data signal line or the clock signal line,
count a period of time during which the data signal line is at a second predetermined level, or during which the clock signal line is at a third predetermined level, and
release a drive state of the data signal line when the period of time exceeds a predetermined value.

16. The communication system according to claim 15, wherein the determination of the error condition is a detection of an error in one bit of the data.

17. The communication system according to claim 15, wherein the first predetermined level and the third predetermined level are an L clock level.

18. The communication system according to claim 17, wherein the first control circuitry is configured to cause the first transmission and reception circuitry to drive the clock signal line to an H clock level after the predetermined period of time has elapsed.

19. The communication system according to claim 14, wherein the first control circuitry is configured to cause the second communication device to release a drive state of the data signal line.

20. A communication method in a communication device, the method comprising:
communicating with from an external communication device via a data signal line and a clock signal line, including transmitting and receiving data via the data signal line and transmitting a clock via the clock signal line;
monitoring a communication condition of at least one of the data signal line and the clock signal line; and
causing the clock signal line to stay at a predetermined level for a predetermined period of time, in response to a determination relating to the communication condition.
